(19) United States
(12) Patent Application Publication
(10) Pub. No.: US 2026/0178897 A1
(43) Pub. Date: Jun. 25, 2026

(54) MULTI-MODAL LARGE LANGUAGE MODELS TRAINED FOR COMPLIANCE

(71) Applicant: Capital One Services, LLC, McLean, VA (US)

(72) Inventors: Ayaz MEHMANI, Teaneck, NJ (US); Ruoyu SHAO, Allen, TX (US); Yiming LIU, McKinney, TX (US); Nilou ABBAS, Keller, TX (US)

(21) Appl. No.: 18/999,002

(22) Filed: Dec. 23, 2024

(51) Int. Cl. G06N 3/08; G06F 21/62; G06N 3/045

(52) U.S. Cl. CPC G06N 3/08; G06F 21/6218; G06N 3/045

(57) ABSTRACT

In some implementations, a machine learning host may receive at least one transcript of at least one call performed by an agent. The machine learning host may provide the at least one transcript to a foundational model, included in the suite of large language models, to receive a first score associated with compliance. The machine learning host may provide the at least one transcript to a rapid response model, included in the suite of large language models, to receive a second score associated with compliance. The machine learning host may generate a report based on the first score and the second score. The machine learning host may transmit, to an administrator device, the report.

### BACKGROUND

Large language models (LLMs) are growing in popularity. LLMs use tokenization to accept natural language inputs and produce natural language outputs. However, LLMs are computationally intensive to train and to execute.

### SUMMARY

Some implementations described herein relate to a system for using a suite of large language models for compliance. The system may include one or more memories and one or more processors communicatively coupled to the one or more memories. The one or more processors may be configured to receive at least one transcript of at least one call performed by an agent. The one or more processors may be configured to provide the at least one transcript to a foundational model, included in the suite of large language models, to receive a first score associated with compliance. The one or more processors may be configured to generate a first report based on whether the first score satisfies a first threshold. The one or more processors may be configured to provide the at least one transcript to a rapid response model, included in the suite of large language models, to receive a second score associated with compliance. The one or more processors may be configured to generate a second report based on whether the second score satisfies a second threshold. The one or more processors may be configured to transmit the first report and the second report to an administrator device.

Some implementations described herein relate to a method of using a suite of large language models for compliance. The method may include receiving, at a machine learning host,

at least one transcript of at least one call performed by an agent. The method may include providing the at least one transcript to a foundational model, included in the suite of large language models, to receive a first score associated with compliance. The method may include providing the at least one transcript to a rapid response model, included in the suite of large language models, to receive a second score associated with compliance. The method may include generating, by the machine learning host, a report based on the first score and the second score. The method may include transmitting, from the machine learning host and to an administrator device, the report.

Some implementations described herein relate to a non-transitory computer-readable medium that stores a set of instructions for using a suite of large language models for compliance. The set of instructions, when executed by one or more processors of a device, may cause the device to transmit, to a machine learning host, a request indicating an agent. The set of instructions, when executed by one or more processors of the device, may cause the device to transmit, to the machine learning host, an authorization to access at least one transcript associated with the agent. The set of instructions, when executed by one or more processors of the device, may cause the device to receive, in response to the request and the authorization, a report based on a first score from a foundational model included in the suite of large language models and a second score from a rapid response model included in the suite of large language models.

### BRIEF DESCRIPTION OF THE DRAWINGS

FIGS. 1A-1D are diagrams of an example implementation relating to using multi-modal LLMs trained for compliance, in accordance with some embodiments of the present disclosure.

FIGS. 2A-2B are diagrams of an example implementation relating to applying an LLM, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIG. 5 is a flowchart of an example process relating to using multi-modal LLMs trained for compliance, in accordance with some embodiments of the present disclosure.

FIG. 6 is a flowchart of an example process relating to receiving compliance reports based on multi-modal LLMs, in accordance with some embodiments of the present disclosure.

### DETAILED DESCRIPTION

The following detailed description of example implementations refers to the accompanying drawings. The same reference numbers in different drawings may identify the same or similar elements.

LLMs use tokenization to accept natural language inputs and produce natural language outputs. For example, LLMs may use a generative pre-trained transformer (GPT) neural network, which uses a transformer deep learning architecture that is pre-trained on large data sets of unlabeled text. However, general-purpose LLMs are computationally intensive to train and to execute. Therefore, refinement to improve accuracy is costlier as compared with smaller and more efficient neural network architectures. Additionally, applying a general-purpose LLM to a

document may result in decreased accuracy when the document includes specialized terms and/or is subject to specialized requirements.

Some implementations described herein enable a foundational LLM to cooperate with a rapid response LLM. As a result, the foundational LLM may provide more generalized analysis of a document, and the rapid response LLM may provide more specialized analysis of the document, which improves accuracy as compared with using a single LLM.

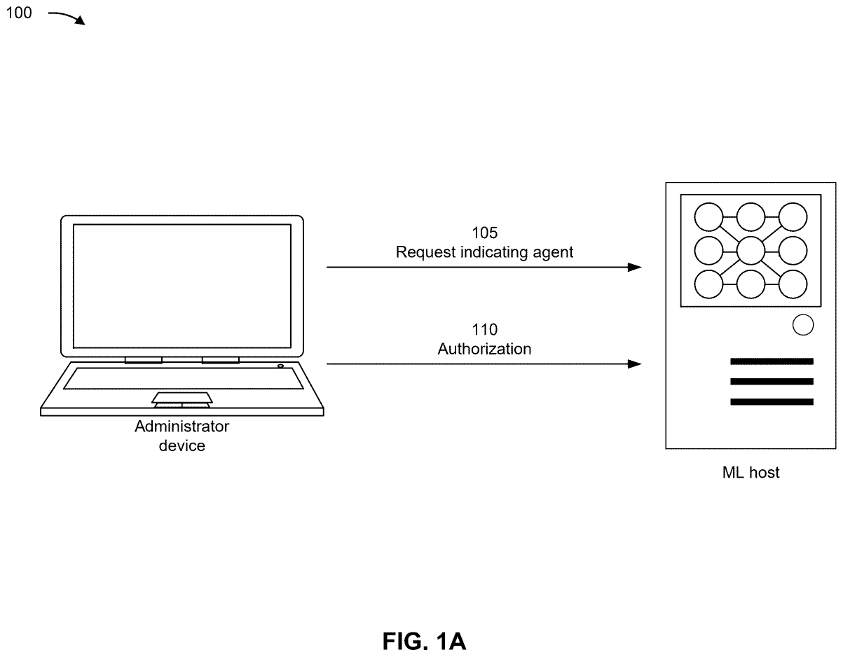

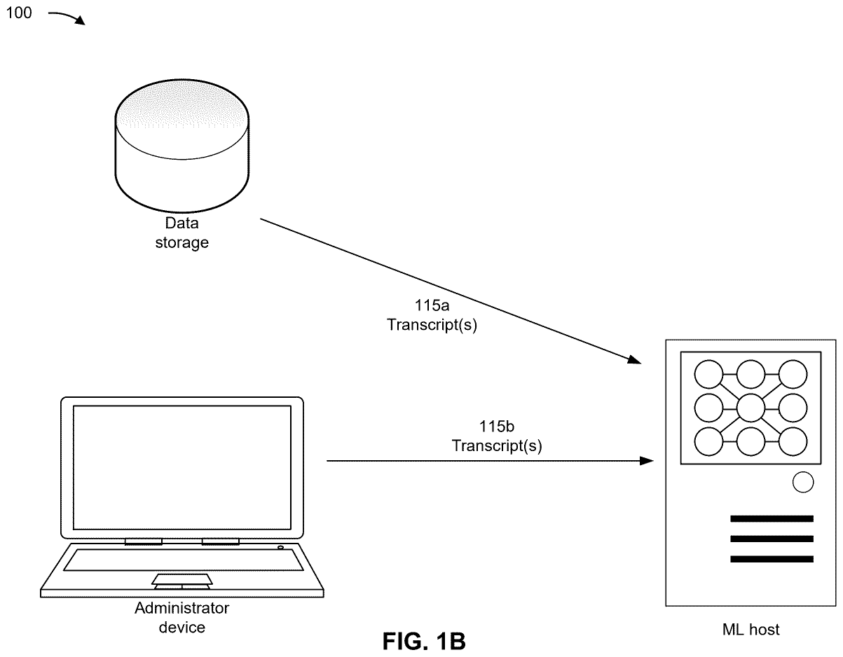

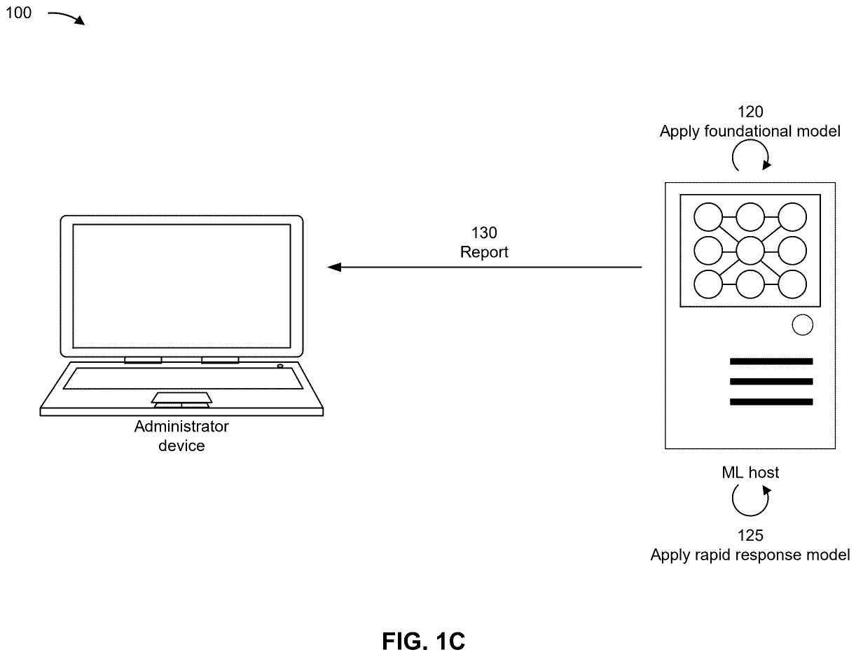

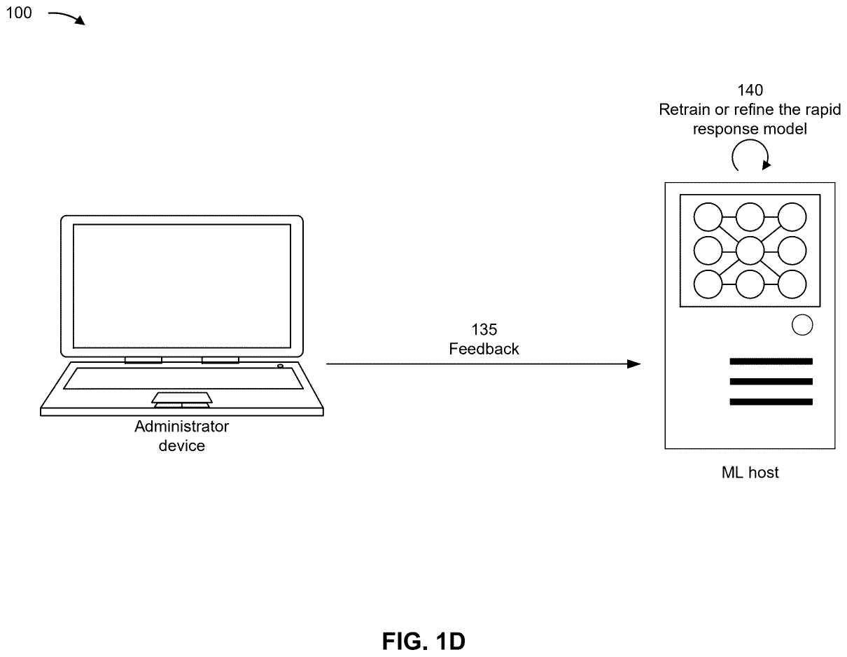

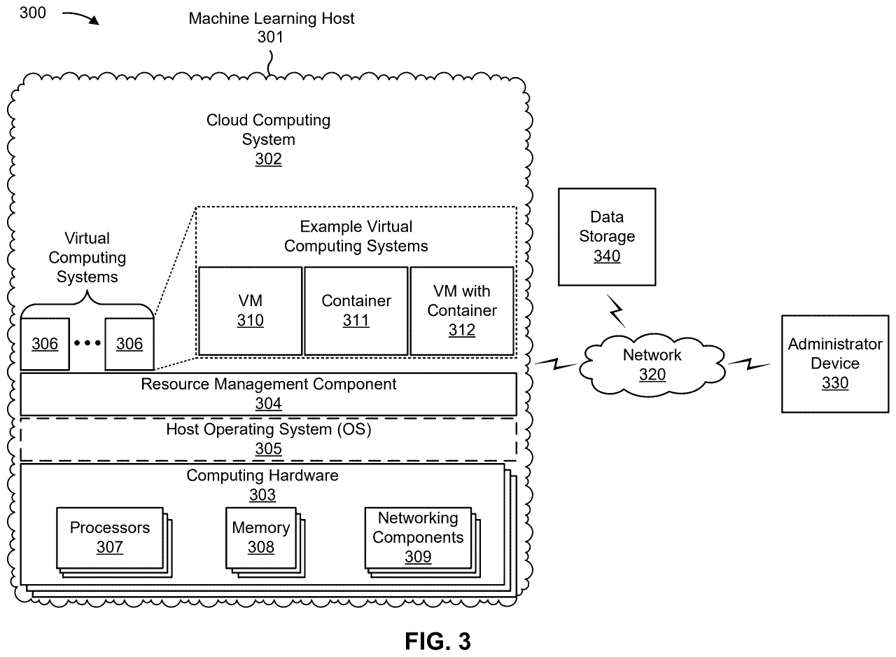

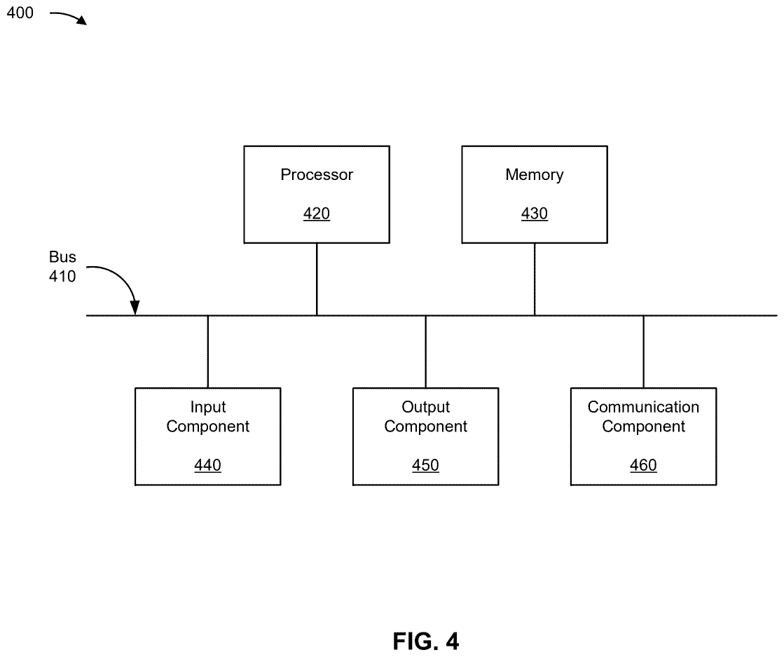

FIGS. 1A-1D are diagrams of an example 100 associated with using multi-modal LLMs trained for compliance. As shown in FIGS. 1A-1D, example 100 includes an administrator device, a machine learning (ML) host, and a data storage. These devices are described in more detail in connection with FIGS. 3 and 4.

As shown in FIG. 1A and by reference number 105, the administrator device may transmit, and the ML host may receive, a request indicating an agent. The request may be a hypertext transfer protocol (HTTP) request, a file transfer protocol (FTP) request, and/or an application programming interface (API) call, among other examples. The request may include (e.g., in a header and/or as an argument) a name, an index, or another type of alphanumeric identifier associated with the agent. The agent may be a representative of a financial institution or another type of agent authorized to negotiate on behalf of an entity (e.g., with an automobile dealership).

In one example, an administrator using the administrator device may provide input (e.g., via an input component of the administrator device) that triggers the administrator device to transmit the request. In some implementations, the administrator may interact with a user interface (UI) to provide the input. For example, a web browser (or another type of application) executed by the administrator device may navigate to a website controlled by (or associated with) the ML host. Accordingly, the administrator device may output a UI (e.g., via an output component of the administrator device) representing the website, and the administrator may interact with the UI to provide the input. Alternatively, the administrator may provide text input (e.g., via a command line or a shell, among other examples) to trigger the administrator device to transmit the request.

In some implementations, the administrator device may include a set of credentials with the request. The set of credentials may include a username and password, a passkey, a certificate, a signature, a private key, and/or biometric information, among other examples. Therefore, the ML host may validate the set of credentials (e.g., before processing the request). In some implementations, the administrator device may transmit the set of credentials separately from the request. For example, the administrator device may transmit the set of credentials initially, and the ML host may accept the request from the administrator device in response to validating the set of credentials. In another example, the ML host may prompt the administrator device in response to the request, and the administrator device may transmit the set of credentials in response to the prompt. Accordingly, the ML host may validate the set of credentials and may process the request in response to validating the set of credentials.

As shown by reference number 110, the administrator device may transmit, and the ML host may receive, an authorization to access at least one transcript associated with the agent. For example, the authorization may include a set of credentials (e.g., a username and password, a passkey, a certificate, a signature, a private key, and/or biometric information, among other examples) associated with the data storage. Additionally, or alternatively, the administrator device may transmit, and the ML host may receive, an indication of a location associated with the at least one transcript. For example, the indication may include a filepath, a web address associated with the data storage, and/or an Internet protocol (IP) address associated with the data storage, among other examples. The administrator device may transmit, and the ML host may receive, the authorization in a same message as the indication of the location or in a separate message. Although the example 100 is described in connection with the authorization being separate from the request, other examples may include the authorization and the request in a same message.

As shown in FIG. 1B and by reference number 115a, the data storage may transmit, and the ML host may receive, at least one transcript of at least one call performed by the agent. The transcript(s) may be encoded as text, whether unstructured (e.g., in a .txt file) or structured (e.g., in a .srt file). In one example, the ML host may transmit (and the data storage may receive) a request for the transcript(s), and the data storage may transmit (and the ML host may receive) the transcript(s) in response to the request. The request may indicate the agent. Additionally, or alternatively, the request may include the authorization. The ML host may transmit the request based on the indication of the location (e.g., determining to transmit the request to the data storage and/or including a filepath for the transcript(s) in the request).

Alternatively, as shown by reference number 115b, the administrator device may transmit, and the ML host may receive, the transcript(s). For example, the administrator device may include the transcript(s) in a same message as the request. In another example, the ML host may prompt the administrator device for any relevant transcripts in response to the request, and the administrator device may transmit the transcript(s) in response to the prompt.

In another example, the ML host may transmit (and the data storage may receive) a subscription indicating the agent, and the data storage may transmit (and the ML host may receive) the transcript(s) in response to the subscription. Accordingly, the data storage may

transmit any transcripts, associated with the agent, to the ML host as the transcripts become available (e.g., are generated, stored, and indexed with the agent).

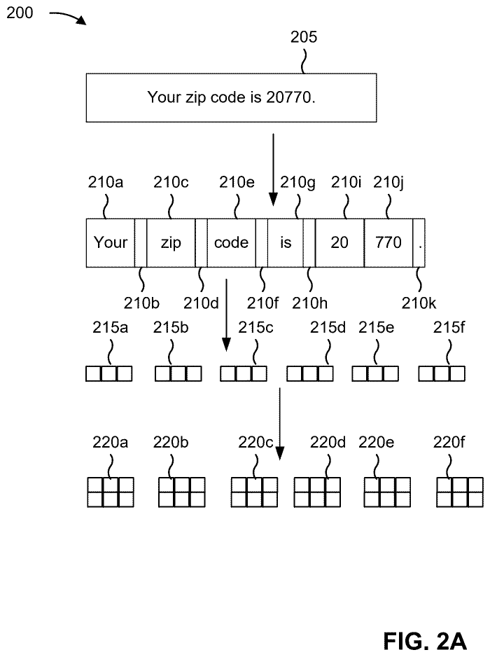

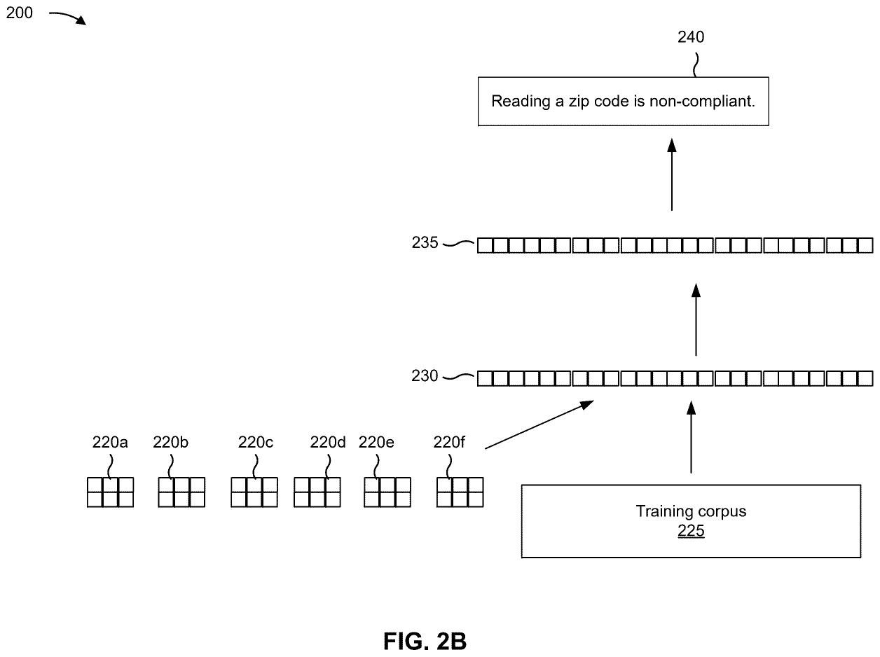

As shown in FIG. 1C and by reference number 120, the ML host may apply a foundational model to the transcript(s). For example, the ML host may provide the transcript(s) to the foundational model in order to receive a first score associated with compliance. The foundational model may be included in a suite of LLMs. For example, the suite of LLMs may include a rapid response model as well as the foundational model. The foundational model may process input and provide output as described in connection with FIGS. 2A-2B.

In some implementations, the foundational model is associated with a first tokenization scheme. For example, the foundational model may be trained using a tokenization scheme related to personally identifiable information (PII) (e.g., rules about which PII may or may not be disclosed on a phone call). The foundational model may use a larger (or otherwise more computationally intensive) tokenization scheme as compared with the rapid response model.

As shown by reference number 125, the ML host may apply the rapid response model to the transcript(s). For example, the ML host may provide the transcript(s) to the rapid response model in order to receive a second score associated with compliance. The rapid response model may be included in the suite of LLMs. For example, the suite of LLMs may include the foundational model as well as the rapid response model. The rapid response model may process input and provide output as described in connection with FIGS. 2A-2B.

In some implementations, the rapid response model is associated with a second tokenization scheme different than the first tokenization scheme (for the foundational model). For example, the foundational model may be trained using a tokenization scheme related to politeness rules. The rapid response model may use a smaller (or otherwise less computationally

intensive) tokenization scheme as compared with the foundational model. Therefore, the ML host may update the rapid response model more frequently. For example, the rapid response model may be trained and/or refined more recently than the foundational model. Accordingly, the ML host may improve accuracy for fast-changing rules (e.g., politeness rules) without incurring comparable computational costs for updating a larger model, such as the foundational model.

The ML host may generate a report based on the first score and the second score. For example, the report may indicate whether the first score satisfies a threshold and whether the second score satisfies the threshold. The threshold may indicate whether training is recommended for the agent. For example, the first score satisfying the threshold may be indicative of the agent providing PII over-the-phone that ought not be revealed on the phone. Similarly, the second score satisfying the threshold may be indicative of the agent being rude.

As shown by reference number 130, the ML host may transmit, and the administrator device may receive, the report. The report may be (or be included in) a file (e.g., a Microsoft® Word document or a portable document format (pdf) file, among other examples).

Although the example 100 is described in connection with a single report, the ML host may instead generate multiple reports. For example, the ML host may generate a first report based on whether the first score satisfies a first threshold and generate a second report based on whether the second score satisfies a second threshold. Therefore, the ML host may transmit, and the administrator device may receive, the first report and the second report (whether in a same file or in different files).

As shown in FIG. 1D and by reference number 135, the administrator device may transmit, and the ML host may receive, feedback associated with the report (or with the second

report). For example, the feedback may include a ranking (whether quantitative, such as a numerical score, and/or qualitative, such as a thumbs-up or thumbs-down or a letter grade) associated with the report. Additionally, or alternatively, the feedback may include indications of locations in the report (e.g., a page number, a line number, a set of pixels, or another type of location indicator) that are particularly good or particularly bad. Additionally, or alternatively, the feedback may include narrative feedback (e.g., unstructured text) about the report. The feedback may be used to retrain (or at least refine) the rapid response model, as shown by reference number 140.

Although the example 100 is described in connection with feedback for the rapid response model, other examples may additionally or alternatively include feedback for the foundational model. For example, the administrator device may transmit, and the ML host may receive, feedback associated with the report (or the first report). The feedback may be used to retrain (or at least refine) the foundational model. Because the foundational model may be retrained and/or refined less frequently than the rapid response model, the ML host may receive, store, and aggregate feedback from multiple administrator devices before retraining and/or refining the foundational model.

By using techniques as described in connection with FIGS. 1A-1D, the ML host may use both the foundational model and the rapid response model. As a result, the foundational model may provide the first report, and the rapid response model may provide the second report, which improves accuracy as compared with using a single model.

As indicated above, FIGS. 1A-1D are provided as an example. Other examples may differ from what is described with regard to FIGS. 1A-1D.

FIGS. 2A-2B are diagrams of an example 200 associated with applying an LLM. The example 200 depicts a process performed by an ML host executing the LLM (e.g., in response to input from an administrator device). These devices are described in more detail in connection with FIGS. 3 and 4.

The LLM may include one or more encoding layers, each encoding layer with a self-attention layer and a feed-forward neural network. FIG. 2A depicts operations performed by an encoding layer.

An input 205 to the LLM may be a natural language sentence (e.g., from a transcript, as described in connection with FIG. 1B). The input may be transformed into a set of tokens 210 using a tokenization scheme. As shown in FIG. 2A, some tokens are for words (e.g., tokens 210a, 210c, 210e, and 210g), some tokens are for numbers (e.g., tokens 210i and 210 j), and some tokens are for punctuation (e.g., tokens 210b, 210d, 210f, 210h, and 210k). The set of tokens 210 are transformed into a set of vectors 215 using an embedding space. Some tokens may be discarded, such that the set of vectors 215 is smaller than the set of tokens (e.g., vectors 215a, 215b, 215c, 215d, 215e, and 215f are generated from the larger set of tokens). Accordingly, the tokenization scheme and the embedding space may be selected to increase accuracy (e.g., for a foundational model) or speed (e.g., for a rapid response model).

As shown in FIG. 2A, the set of vectors 215 may be transformed into a set of matrices 220. The set of matrices 220 may encode tokens as well as attention scores associated with the tokens. The attention scores mathematically represent relations between words in the input 205 (e.g., grammatical and logical relations).

The LLM may further include one or more decoding layers, each decoding layer with a self-attention layer, an attention layer, and a feed-forward neural network. FIG. 2B depicts operations performed by a decoding layer. The set of matrices 220 from the encoding layer(s) may be transformed into a score vector 230. A size of the score vector 230 may be determined by a size of a training corpus 225 for the LLM. Accordingly, the training corpus 225 may be selected to increase accuracy (e.g., by increasing output vocabulary) or speed (e.g., by limited output vocabulary and thus limiting the size of the score vector 230).

The score vector 230 may be transformed into a probability vector 235 (e.g., using a probability function and/or a normalization function). The probability vector 235 may indicate a subsequent word to include in output from the LLM. Accordingly, an output sentence 240 may be constructed one word at a time using the decoding layer(s).

As indicated above, FIGS. 2A-2B are provided as an example. Other examples may differ from what is described with regard to FIGS. 2A-2B.

FIG. 3 is a diagram of an example environment 300 in which systems and/or methods described herein may be implemented. As shown in FIG. 3, environment 300 may include a machine learning host 301, which may include one or more elements of and/or may execute within a cloud computing system 302. The cloud computing system 302 may include one or more elements 303-312, as described in more detail below. As further shown in FIG. 3, environment 300 may include a network 320, an administrator device 330 and/or a data storage 340. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The

resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some

implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the machine learning host 301 may include one or more elements 303-312 of the cloud computing system 302, may execute within the cloud computing system 302, and/or may be hosted within the cloud computing system 302, in some implementations, the machine learning host 301 may not be cloud-based (e.g., may be implemented outside of a cloud computing system) or may be partially cloud-based. For example, the machine learning host 301 may include one or more devices that are not part of the cloud computing system 302, such as device 400 of FIG. 4, which may include a standalone server or another type of computing device. The machine learning host 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The administrator device 330 may include one or more devices capable of receiving, generating, storing, processing, and/or providing information associated with agents and/or transcripts, as described elsewhere herein. The administrator device 330 may include a communication device and/or a computing device. For example, the administrator device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 330 may communicate with one or more other devices of environment 300, as described elsewhere herein.

The data storage 340 may include one or more devices capable of receiving, generating, storing, processing, and/or providing information associated with transcripts, as described elsewhere herein. The data storage 340 may include a communication device and/or a computing device. For example, the data storage 340 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data storage 340 may communicate with one or more other devices of environment 300, as described elsewhere herein.

The number and arrangement of devices and networks shown in FIG. 3 are provided as an example. In practice, there may be additional devices and/or networks, fewer devices and/or

networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with multi-modal LLMs trained for compliance. The device 400 may correspond to an administrator device 330 and/or a data storage 340. In some implementations, an administrator device 330 and/or a data storage 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of

instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

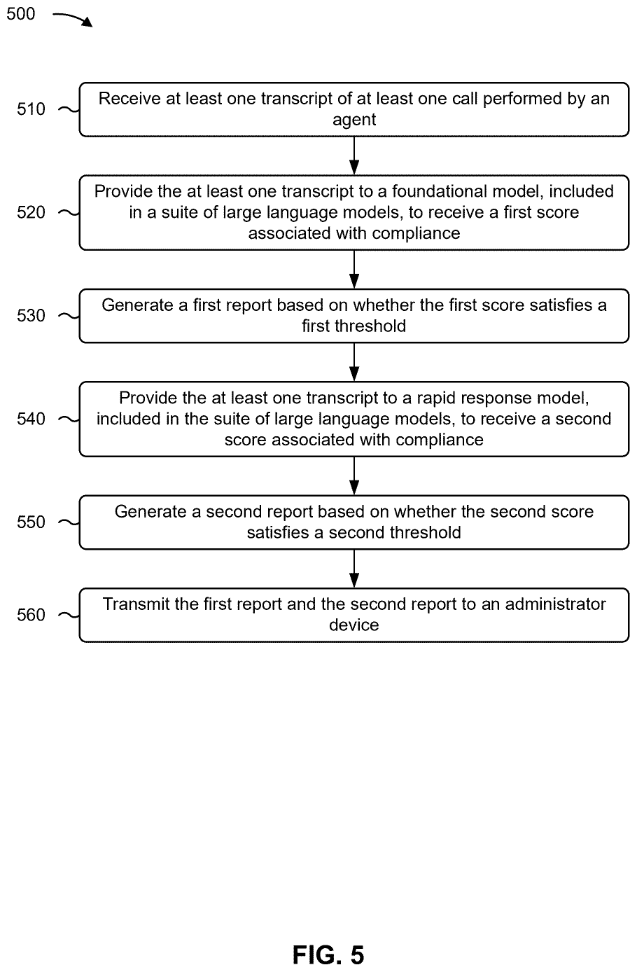

FIG. 5 is a flowchart of an example process 500 associated with using multi-modal LLMs trained for compliance. In some implementations, one or more process blocks of FIG. 5 may be performed by a machine learning host 301. In some implementations, one or more process blocks of FIG. 5 may be performed by another device or a group of devices separate from or including the machine learning host 301, such as an administrator device 330 and/or a data storage 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving at least one transcript of at least one call performed by an agent (block 510). For example, the machine learning host 301 (e.g., using processor 420, memory 430, input component 440, and/or communication component 460) may receive at least one transcript of at least one call performed by an agent, as described above in connection with FIG. 1B. As an example, the machine learning host 301 may receive the transcript(s) from a data storage (e.g., in response to a request or a subscription). In another example, the machine learning host 301 may receive the transcript(s) from an administrator device.

As further shown in FIG. 5, process 500 may include providing the at least one transcript to a foundational model, included in a suite of large language models, to receive a first score associated with compliance (block 520). For example, the machine learning host 301 (e.g., using processor 420, memory 430, and/or communication component 460) may provide the at least one transcript to a foundational model, included in a suite of large language models, to receive a first score associated with compliance, as described above in connection with reference number 120 of FIG. 1C. As an example, the foundational model may process input and provide output as described in connection with FIGS. 2A-2B.

As further shown in FIG. 5, process 500 may include generating a first report based on whether the first score satisfies a first threshold (block 530). For example, the machine learning host 301 (e.g., using processor 420 and/or memory 430) may generate a first report based on whether the first score satisfies a first threshold, as described above in connection with FIG. 1C.

As an example, the first score satisfying the first threshold may be indicative of the agent providing PII over-the-phone that ought not be revealed on the phone.

As further shown in FIG. 5, process 500 may include providing the at least one transcript to a rapid response model, included in the suite of large language models, to receive a second score associated with compliance (block 540). For example, the machine learning host 301 (e.g., using processor 420, memory 430, and/or communication component 460) may provide the at least one transcript to a rapid response model, included in the suite of large language models, to receive a second score associated with compliance, as described above in connection with reference number 125 of FIG. 1C. As an example, the rapid response model may process input and provide output as described in connection with FIGS. 2A-2B.

As further shown in FIG. 5, process 500 may include generating a second report based on whether the second score satisfies a second threshold (block 550). For example, the machine learning host 301 (e.g., using processor 420 and/or memory 430) may generate a second report based on whether the second score satisfies a second threshold, as described above in connection with FIG. 1C. As an example, the second score satisfying the second threshold may be indicative of the agent being rude.

As further shown in FIG. 5, process 500 may include transmitting the first report and the second report to an administrator device (block 560). For example, the machine learning host 301 (e.g., using processor 420, memory 430, and/or communication component 460) may transmit the first report and the second report to an administrator device, as described above in connection with FIG. 1C. As an example, the first report and the second report may be included in one or more files (e.g., Microsoft Word documents and/or pdf files, among other examples).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D and/or FIGS. 2A-2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

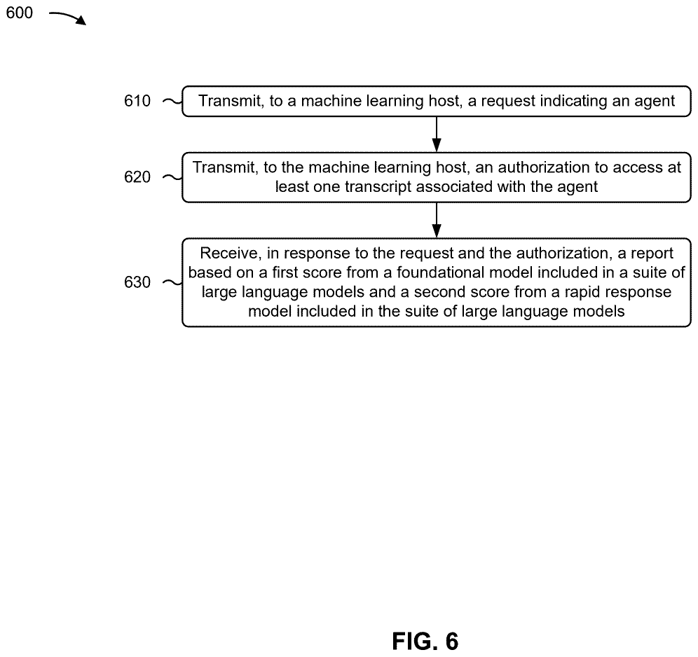

FIG. 6 is a flowchart of an example process 600 associated with receiving compliance reports based on multi-modal LLMs. In some implementations, one or more process blocks of FIG. 6 may be performed by an administrator device 330. In some implementations, one or more process blocks of FIG. 6 may be performed by another device or a group of devices separate from or including the administrator device 330, such as a machine learning host 301 and/or a data storage 340. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to a machine learning host, a request indicating an agent (block 610). For example, the administrator device 330 (e.g., using processor 420, memory 430, and/or communication component 460) may transmit, to a machine learning host, a request indicating an agent, as described above in connection with reference number 105 of FIG. 1A. As an example, an administrator using the administrator device 330 may provide input (e.g., via input component 440) that triggers the administrator device 330 to transmit the request. The input from the administrator may indicate the agent.

As further shown in FIG. 6, process 600 may include transmitting, to the machine learning host, an authorization to access at least one transcript associated with the agent (block 620). For example, the administrator device 330 (e.g., using processor 420, memory 430, and/or communication component 460) may transmit, to the machine learning host, an authorization to access at least one transcript associated with the agent, as described above in connection with reference number 110 of FIG. 1A. As an example, the authorization may include a password, a certificate, a signature, a token, and/or another set of credentials that the machine learning host may use to access the transcript(s).

As further shown in FIG. 6, process 600 may include receiving, in response to the request and the authorization, a report based on a first score from a foundational model included in a suite of large language models and a second score from a rapid response model included in the suite of large language models (block 630). For example, the administrator device 330 (e.g., using processor 420, memory 430, and/or communication component 460) may receive, in response to the request and the authorization, a report based on a first score from a foundational model included in a suite of large language models and a second score from a rapid response model included in the suite of large language models, as described above in connection with reference number 130 of FIG. 1C. As an example, the administrator device 330 may receive a file including the report.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1D. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using a suite of large language models for compliance, the system comprising:
one or more memories; and
one or more processors, communicatively coupled to the one or more memories, configured to:
receive at least one transcript of at least one call performed by an agent;
provide the at least one transcript to a foundational model, included in the suite of large language models, to receive a first score associated with compliance;
generate a first report based on whether the first score satisfies a first threshold;
provide the at least one transcript to a rapid response model, included in the suite of large language models, to receive a second score associated with compliance;
generate a second report based on whether the second score satisfies a second threshold; and
transmit the first report and the second report to an administrator device.

2. The system of claim 1, wherein the rapid response model was trained or refined more recently than the foundational model.

3. The system of claim 1, wherein the foundational model is associated with a first tokenization scheme, and the rapid response model is associated with a second tokenization scheme different than the first tokenization scheme.

4. The system of claim 1, wherein the one or more processors are configured to:
receive, from the administrator device, an indication of a location associated with the at least one transcript; and
transmit a request for the at least one transcript based on the indication of the location,
wherein the at least one transcript is received in response to the request.

5. The system of claim 1, wherein the one or more processors are configured to:
transmit, to a data storage, a subscription indicating the agent,
wherein the at least one transcript is received based on the subscription.

6. The system of claim 1, wherein the one or more processors, to receive the at least one transcript, are configured to:
receive the at least one transcript from the administrator device.

7. The system of claim 1, wherein the one or more processors are configured to:
receive, from the administrator device, feedback associated with the second report; and
retrain or refine the rapid response model using the feedback.

8. A method of using a suite of large language models for compliance, comprising:
receiving, at a machine learning host, at least one transcript of at least one call performed by an agent;
providing the at least one transcript to a foundational model, included in the suite of large language models, to receive a first score associated with compliance;
providing the at least one transcript to a rapid response model, included in the suite of large language models, to receive a second score associated with compliance;
generating, by the machine learning host, a report based on the first score and the second score; and
transmitting, from the machine learning host and to an administrator device, the report.

9. The method of claim 8, wherein the foundational model is trained using a tokenization scheme related to personally identifiable information.

10. The method of claim 8, wherein the rapid response model is trained using a tokenization scheme related to politeness rules.

11. The method of claim 8, further comprising:
receiving, from the administrator device, a set of credentials,
wherein the at least one transcript is received using the set of credentials.

12. The method of claim 8, wherein the report comprises a file.

13. The method of claim 8, wherein the report indicates whether the first score satisfies a threshold and whether the second score satisfies the threshold.

14. A non-transitory computer-readable medium storing a set of instructions for using a suite of large language models for compliance, the set of instructions comprising:
one or more instructions that, when executed by one or more processors of a device, cause the device to:
transmit, to a machine learning host, a request indicating an agent;
transmit, to the machine learning host, an authorization to access at least one transcript associated with the agent; and
receive, in response to the request and the authorization, a report based on a first score from a foundational model included in the suite of large language models and a second score from a rapid response model included in the suite of large language models.

15. The non-transitory computer-readable medium of claim 14, wherein the one or more instructions, when executed by the one or more processors, cause the device to:
receive input from a user of the device,
wherein the request is transmitted in response to the input.

16. The non-transitory computer-readable medium of claim 14, wherein the one or more instructions, when executed by the one or more processors, cause the device to:
receive input from a user of the device,
wherein the authorization is transmitted in response to the input.

17. The non-transitory computer-readable medium of claim 14, wherein the one or more instructions, when executed by the one or more processors, cause the device to:
transmit, to the machine learning host, feedback associated with the report.

18. The non-transitory computer-readable medium of claim 14, wherein the request includes an identifier associated with the agent.

19. The non-transitory computer-readable medium of claim 14, wherein the authorization comprises a set of credentials.

20. The non-transitory computer-readable medium of claim 14, wherein the report indicates whether the first score satisfies a first threshold and whether the second score satisfies a second threshold.
